(19) United States
(12) Patent Application Publication
(10) Pub. No.: US 2010/0299016 A1
(43) Pub. Date: Nov. 25, 2010

(54) ACTIVATION SYSTEM FOR A ROBOTIC VEHICLE

(75) Inventors: Ulrich-Lorenze Benzler, Langenhagen (DE); Klaus Marx, Stuttgart (DE); Soenke Carstens-Behrens, Bonn (DE); Wolfgang Niehsen, Bad Salzdetfurth (DE); Thilo Koeder, Gerlingen (DE); Christoph Koch, Stuttgart (DE); Thomas Brosche, Gerlingen (DE); Joachim Platzer, Remseck-Hochberg (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/665,883

(22) PCT Filed: May 16, 2008
(86) PCT No.: PCT/EP08/56016

§ 371 Date: Jul. 23, 2010

(30) Foreign Application Priority Data
Jun. 21, 2007 (DE) 10 2007 028 519.3
Nov. 8, 2007 (DE) 10 2007 053 311.1

(51) Int. Cl. G05D 1/00

(52) U.S. Cl. 701/26

(57) ABSTRACT

The invention relates to an activation system (1) for a robotic vehicle (2), comprising at least one external camera (8) configured for generating image data of a work area (3) and of at least one robotic vehicle (2), and comprising at least one external logic unit (10) configured for determining the position of the at least one robotic vehicle (2) based on the image data generated by the camera (8), and comprising an external transmission unit (15, 20) configured for transmitting driving instructions, and comprising a receiving unit (16, 21) configured for receiving the driving instructions, and further comprising a controller (18) for activating drive means of at least one robotic vehicle (2) based on the driving instructions.

### STATE OF THE ART

The invention relates to an activation system for a robotic vehicle.

Activation systems are known for autonomous lawnmowers, which comprise a live conductor that is buried at the external border of the work area (lawn). Corresponding sensors on the lawnmower detect if the external border is driven over and as a result a control unit causes a turning maneuver of the lawnmower. It is also complex to install the known activation systems and they only allow a coincidental navigation. Marker-based lawnmower robotic vehicles are for example described in EP 55 04 73 B1 and U.S. Pat. No. 6,984, 952 B2.

An improved activation system for autonomous lawnmowers is known from GB 2 277 152 A1. The known activation system comprises a number of landmarks, which are distanced from each other and which border a work area (lawn). The autonomous lawnmower communicates actively with the landmarks in order to determine its position and to calculate a driving route based on these position data with the aid of a logic unit.

In particular at irregularly outlined lawnmowers a number of landmarks is required. It is furthermore a disadvantage that the lawnmower (robotic vehicle) has a complex construction due to the provision of a logic unit for calculating the driving route and is therefore interference-prone.

It is known from EP 1 704 766 A1 to equip a lawnmower with infrared sensors for analyzing the immediate surroundings of the lawnmower and to activate the lawnmower with the aid of an internal logic unit based on the sensor data. A global position detection is not possible with the known activation system and therefore it is not possible to ensure that a complete mowing of the lawn takes place.

Robotic vehicles are known from EP 1 041 220 A2, EP 1 302 611 A2, WO 2005/045162 A1, EP 1 022 411 A2, US 2004 007 4524 A1, WO 2004/019295 A1, EP 1 489 249 A2, EP 6 596 03 A1, ES 2 074 401 A1, ER 2 685 374 A1, JP 2005/257441 A, EP 1 500 83 A1 as well as KR 2004/101953 A, which carry out a change of direction by a defined angle after detecting a wall contact and then continue their movement linearly. The disadvantage of these robotic vehicles is that the robotic vehicles are controlled by a sheer coincidental navigation, so that it is not possible to drive along an optimized work area path. A complete driving along is not guaranteed for random surface and takes correspondingly long.

Robotic vehicles are known from FR 2 781 243 A1, U.S. Pat. No. 556,937 A and U.S. Pat. No. 59,743,447 A1, whose control unit carries out an automatic trajectory correction for following a path that has been previously programmed by an operator. The programming of the path is complex and mostly requires the support of an expert.

### DISCLOSURE OF THE INVENTION

### Technical Task

The invention is based on the task to suggest an alternative activation system for robotic vehicles, which allows the use of comparably simply constructed robotic vehicles.

### Technical Solution

This task is solved by the characteristics of claim 1. Advantageous improvements of the invention are stated in the sub-claims. All combinations of at least two characteristics that are stated in the description, the claims and/or figures also fall within the scope of the invention.

The invention is based on the idea to provide at least one camera that is arranged outside the robotic vehicle for detecting the work area as well as the robotic vehicle. The camera is preferably arranged above the work area, so that a section of the work area can be detected that is as big as possible with the camera, preferably a digital video camera. If the work area is contoured in such a way that it cannot be completely detected by a single camera it is advantageous to provide at least a second external camera, which means one that is arranged outside the robotic vehicle. It is furthermore possible to arrange the at least one camera pivoted and to arrange it with the aid of the logic unit in such a way that it follows the movement of the robotic vehicle. The camera or the cameras generates/generate image data, which is transferred to the logic unit. The logic unit can thereby be a part of the camera or be arranged as a separate component with a distance to a camera, whereby the transfer of the image data can for example take place over a data cable and/or a radio interface. A personal computer, a PDA or a mobile phone can for example serve as logic unit. The logic unit determines the position of the robotic vehicle on the work area based on the image data and calculates driving instructions for the robotic vehicle based on the determined position for proceeding on the work area. It falls thereby within the scope of the invention that the image data that is generated by the at least one external camera is revised either in the logic unit or in front of the logic unit, in particular filtered or reviewed in a different way. The driving instructions that are calculated by the logic unit are transmitted over a transmitting unit that is connected in a signal-conducting way with the logic unit and received by a receiving unit that is arranged at the robotic vehicle. The receiving unit of the robotic vehicle is on the other hand connected to a simply constructed control unit in a signal-conducting unit, which is arranged at the robotic vehicle and which activates the drive means of the robotic vehicle according to the received driving instructions. The drive means are thereby construed in such a way that the robotic vehicle can be driven and steered by them. The activation system according to the invention has essential advantages compared to the known activation systems. Because wide areas can be detected with the aid of the at least one camera it is usually sufficient to provide only one camera. By all means usually less cameras than landmarks have to be used in an activation system that is known from the state of the art. A further advantage of the activation system according to the invention is that the robotic vehicle can be construed simply because the logic unit, which preferably creates a digital map of the work area, is arranged outside of the robotic vehicle. This causes on the other hand that the robotic vehicle can be produced less interference-prone and cheaper. Therefore the entire activation system according to the invention is less interference-prone, since it is possible to arrange the logic unit in an area that is mostly protected from external environmental influences, for example within a house or under a roofing. If a usual personal computer is for example used as logic unit only a corresponding program has to be installed on it, which is able to process the image data that is generated by the at least one camera and to detect the position of the robotic vehicle based on this data and to calculate corresponding driving instructions, which are then transmitted by the transmitting unit, for example a WLAN-transmitting unit, to the receiving unit of the robotic vehicle. A further essential advantage of the activation system according to the invention is that close range sensors at the robotic vehicle can be waived. But for a fine tuning such sensors can be provided optionally.

An internal logic unit can also be provided in addition or as an alternative to the provision of an external logic unit, thus a logic unit, which is a component of the robotic vehicle, or which is arranged in or at it. Preferably the logic unit is thereby arranged in a moisture-sealed housing. Assuming that an internal logic unit is provided the image data that is detected by the digital camera and the external transmitting unit has to be transmitted to the internal receiving unit at the robotic unit, which is connected in a signal-conducting way to the internal logic unit, which on the other hand evaluates the image data and determines corresponding driving instructions for the control unit, which then activates the driving means correspondingly. It is thereby possible that the logic unit and the control unit are put together in one component. Alternatively the logic unit and the control unit are connected with each other in a signal-conducting way. The camera is preferably a color digital camera.

As an improvement of the invention it is advantageously provided that the external logic unit is construed in such a way that it detects the internal and/or external border of the work area based on the image data of the at least one camera. The external logic unit can for example calculate the borders with the aid of contrast differences between adjoining image points. The external logic unit is construed in such a way that the determined border of the work area flows into the calculation of the driving instructions, in particular in such a way that the robotic vehicle does not exceed the borders, thus does not leave the work area.

It is advantageously provided according to an improvement of the invention that the logic unit additionally or alternatively detects static and/or moved, which means temporary obstacles within the work area and considers them when calculating the driving instructions for the robotic vehicle, in particular in such a way that the robotic vehicle does not collide with the obstacles, thus changes the driving direction or stops.

For optimizing the driving path of the robotic vehicle it is advantageous if the external logic unit detects the orientation of the robotic vehicle from the image data and considers this information when calculating the driving instructions, for example in such a way that at first a rotation takes place before the robotic vehicle is directed into a linear direction.

It is particularly advantageous if the external logic unit considers further data when calculating the driving instructions. It is advantageous if the logic unit considers for example weather data, which is especially retrieved over the internet or a weather station that belongs to the activation system. The external logic unit can thereby for example be construed in such a way that the robotic vehicle drives into a parking position for example a garage in the case of precipitations and/or too high wind forces. Additionally or alternatively the logic unit can for example consider time data and/or date data, for example from the internet or a clock that belongs to the activation system, for example in such a way that the robotic vehicle does only proceed on the work area at certain times and/or only at certain days, in particular during weekdays.

One embodiment is particularly advantageous, at which the logic unit detects differently conditioned sections of the work area, for example a mowed or a not mowed section of the work area based on the image data and then considers this information when calculating the driving instructions, in particular in such a way that the robotic vehicle does only or preferably move on one of those sections, in particular the not mowed lawn section.

One embodiment is particularly advantageous, at which the borders of the work area can be determined manually, in particular in such a way that the borders that are detected automatically by the logic unit are reworked. The logic unit is therefore preferably equipped with a corresponding input unit and/or a corresponding visualizing unit for displaying the work area or the borders of the work area. Preferably obstacles and/or external or internal borders can be manually pre-determined or removed or driving patterns, meaning driving strategies, can be provided or driving strategies that are suggested by the logic unit can be reworked.

As an improvement of the invention it is advantageously provided that the logic unit is construed in such a way that the driving instructions are calculated in such a way that the work area is driven along according to a certain driving pattern, which means a certain driving strategy. Thereby a time-optimized and therefore energy-consumption-optimized driving along the work area can be realized and/or the complete driving along the work area, for example on parallel and/or overlapping tracks. The last embodiment is particularly advantageous if the robotic vehicle is a autonomous lawnmower. It is possible that the logic unit suggests different driving patterns and an operator can select an individually preferred driving strategy over an input unit. The input unit can preferably revise and/or determine areas within the work area (internal border) that should be omitted, which means not driven along. It is also possible that the logic unit is provided with new driving strategies, which can for example be read or taken from the internet or a data carrier, in particular in exchange for fees.

Preferably a bidirectional communication connection exists between the logic unit and the robotic vehicle. This embodiment enables that the robotic vehicle sends status information to the logic unit, which considers them when calculating the driving instructions. After detecting a low accumulator load status the logic unit can for example activate the robotic vehicle in such a way that it docks into a charging station. For optimizing the navigation/guiding of the robotic vehicle it is advantageous if the robotic vehicle determines odometry data and/or the environmental character with corresponding sensors, for example with the aid of IR-sensors, and transfers this data with the aid of a transmitting unit to a receiving unit that is connected with the logic unit.

In one embodiment the lawnmower can disclose the takeover of control over the driving navigation over the communication connection, for example if near-field sensors at the vehicle detect an obstacle. For increasing the data security it is advantageous to use known security mechanisms (for example communication protocols with a checksum, handshaking etc.).

It is advantageous to equip the communication with a so-called watchdog. Normally the data transfer takes preferable place cyclically. If the data transfer stays away for a defined time range or if no valid data is transferred in a defined time range the system goes into a secure status (the robotic vehicle stops for example).

One embodiment is preferred, at which the logic unit detects the position and/or orientation of the robotic vehicle only with the aid of the distinctive shape and/or color of the robotic vehicle and if necessary follows the movement. In order to optimize the position and/or orientation detection it is however advantageous to place marks at the robotic vehicle, for example LEDs in a suitable arrangement, in order to simplify the identification of the robotic vehicle and therefore the position and/or orientation determination.

The robotic vehicle can be implemented in different configurations. The robotic vehicle can for example be implemented as a snow cleaning vehicle, as leaf collecting vehicle, as grass collecting vehicle, thatching vehicle, or as weeding vehicle etc. One embodiment is preferred, at which the robotic vehicle is implemented as a lawnmower with a mower. Another embodiment is especially preferred, at which the logic unit does not only calculate the driving instructions for the robotic vehicle based on image data but additionally generates a starting instruction and/or stopping instruction for a tool of the robotic vehicle based on image data, whereby the starting instruction or the stopping instruction is transmitted to the receiving unit of the robotic vehicle with the aid of the transmitting unit and correspondingly converted by the transmitting unit. In order to save electric energy it is thus for example possible that a mower is only operated in the case that the robotic vehicle is moving on a not mowed section of the work area. The mower can also be switched off if an obstacle, in particular a moved obstacle, is detected by the logic unit in the area of the robotic vehicle.

As an improvement of the invention it is advantageously provided that the internal or external logic unit automatically calculates a trajectory for the robotic vehicle based on the image data that is in particular continuously determined by the external camera. This trajectory is preferably calculated or generated in such a way that the entire work area or a default and/or by an operator pre-defined section of the work area is at least almost completely driven along, preferably without driving along one surface section several times. The last limitation or driving optimization does not apply conclusively for the last driving route or the last track section of the trajectory, in particular not if the diameter of the work area cannot be divided integrally by the path widths or track widths of the paths or tracks that have to be driven along.

One embodiment is particularly advantageous, at which the trajectory for the robotic vehicle is calculated in such a way that it drives along the work area circularly clockwise and/or counter-clockwise, which means in rounds. One embodiment is thereby preferred, at which the trajectory is calculated in such a way that the robotic vehicle constantly drives either clockwise or counter-clockwise. But one embodiment can also be realized, at which it is switched between a clockwise driving along the work area and a counter-clockwise driving. The trajectory calculation preferably takes place with the assistance of the image processing operation erosion, in particular with a gradually increased or reduced erosion filter mask (for example circular or rectangular masks for round or rectangular forms). In other words circular lanes that are oriented at the external and/or internal border are calculated, whereby the diameters of the lanes that have to be driven along become gradually bigger or gradually smaller by increasing or reducing the erosion filter mask depending on whether one begins with the driving in the work area on the inside or outside. In other words, it is switched after driving along one track by the robotic vehicle to the next adjoining track that is adjusted to the external or internal border or border contour. The adjoining driving tracks are thereby usually not (exactly) parallel, but their topology (shape) changes in the style of the adjoining driving track.

As an improvement of the invention it is advantageously provided that the logic unit calculates the driving instructions depending on distance information that is determined from the image data of the camera, due to which the control unit activates the drive means, in such a way that the robotic vehicle drives along the work area in several rounds, which means ring tracks, whereby the round contours are oriented at the internal or external border contour. The contours of the ring tracks approach thereby the contour of the external or internal border in an increased or reduced scale. While one round is driven, which means while the robotic vehicle drives along a ring track, the control unit activates the drive means depending on the driving instructions that have been calculated by the logic unit in such a way that the robotic vehicle observes approximately one constant, round-specific distance (depending on topologic changes by the erosion) to the internal or external border. After the end of a round, thus after a ring has been driven along by the robotic vehicle, preferably completely, the robotic vehicle shifts to an adjoining bigger or smaller ring or to a bigger or smaller round, whereby the contour of this ring or ring track is also adjusted to the contour of the external or internal border due to observing the approximately constant distance, or it corresponds with this contour in a changed scale and with topological changes, contingent on the use of the image processing operation erosion. In this adjoining round a changed approximately constant distance to the border contour is maintained.

Particularly advantageous is an embodiment, at which the width of the ring track corresponds at least approximately with the width of the robotic vehicle transversely to the driving direction or the width of a working element of the robotic vehicle, for example the width of a cutting knife or a cleaning device, so that the entire work area can be completely “worked off” preferably without driving across one surface section several times.

One embodiment of the activation system is particularly preferred, at which the robotic vehicle is construed as pool-robotic vehicle, thus in particular as filter vehicle and/or cleaning or purifying vehicle. Such pool robotic vehicles drive in particular on the bottom of a pool, which then creates the work area.

In order for the digital camera, which is constructed above the pool, the swimming bath etc. and which is in particular construed as color camera, to be able to distinguish the robotic vehicle from the environment, in particular from the blue and reflecting water surface, it is provided as an improvement of the invention that the robotic vehicle is equipped with a swimmer, which swims on the water surface. It is for example possible to carry the swimmer along on a rod, in particular a telescope rod that is pivoted. The swimmer is preferably movable relative to and along the longitudinal direction of the rod.

In order to ensure that the rod remains vertical despite the flexible arrangement even at a forward movement of the robotic vehicle, a further swimmer is provided below the swimmer, which is firmly connected to the rod and which provides sufficient lift to widen the rod vertically.

In particular when the color of the swimmer (preferably red) differs from the color of the water surface (usually blue) the logic unit can determine the exact position of the swimmer and therefore of the robotic vehicle with the aid of the image data that is delivered by the camera. Additionally or alternatively a form matching based on an edge detection and/or color segmentation can be carried out. The communication between an external logic unit and the control unit takes preferably place by radio devices, whereby a corresponding receiver can be provided for the swimmer at a guiding rod. Alternatively it is also possible to connect the logic unit and the sensor unit over a cable connection in a signal-conducting way. It is also possible that the camera communicates over a cable a radio with a logic unit that is construed as internal logic unit.

One embodiment of the swimmer is particularly advantageous, at which its width, which means its range transversely to the driving direction corresponds at least approximately with the width of the robotic vehicle or the width of a work element, for example a cleaning device, etc. In particular at such an embodiment a calibration is not required.

### SHORT DESCRIPTION OF THE DRAWINGS

Further advantages, characteristics and details of the invention arise from the following description of preferred embodiments as well as with the aid of the drawings, which show in:

FIG. 1 an activation system for a robotic vehicle in a schematic illustration,

FIG. 2 a trajectory that is automatically calculated by the logic unit, and

FIG. 3 a schematic illustration of an activation system for a robotic vehicle that is construed as pool robotic vehicle.

### EMBODIMENTS OF THE INVENTION

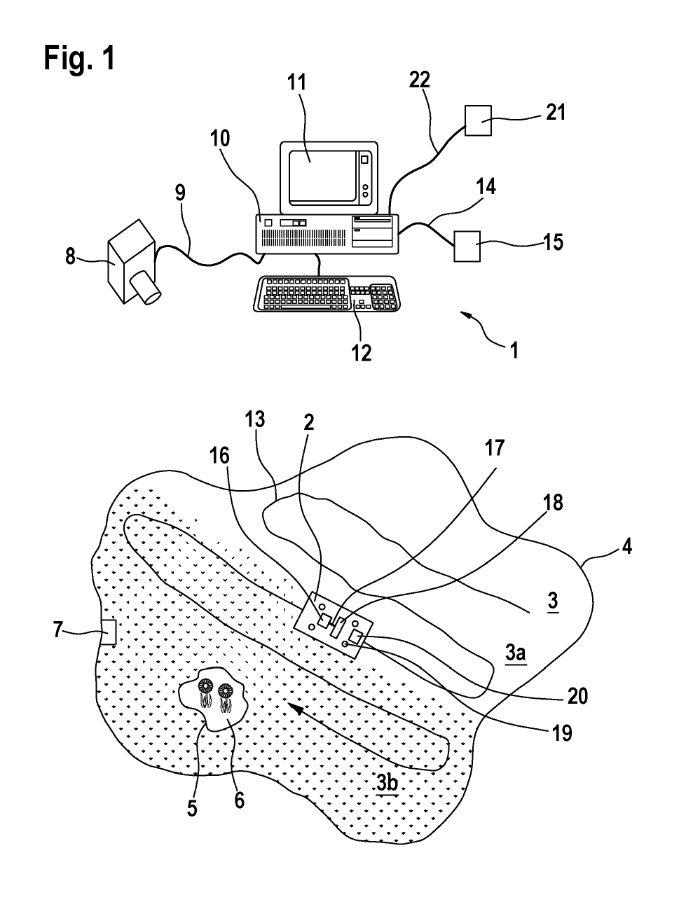

FIG. 1 schematically shows an activation system 1 for a robotic vehicle 2 that is construed as lawnmower. The robotic vehicle 2 comprises not shown drive means, in particular a drive motor and a steering device for steering the robotic vehicle 2 or two drive units, which both together create a differential drive. In the shown embodiment the drive motor is construed as electric motor, which is operated with the aid of an accumulator that is also not shown.

The robotic vehicle 2 is located on a work area 3 (lawn) with an external border 4. A static obstacle 6, in the present embodiment a flowerbed, is located within this work area 3 within an internal border 5.

A charging station 7 is located at the edges within the work area 3 for charging the accumulator of the robotic vehicle 2.

The entire work area 3 is optically detected by a camera 8, which is construed as digital video camera and which is located outside and above the work area 3. The camera 8 can for example be mounted at a gable etc. If necessary several cameras 8 can be provided. The camera 8 is connected over a data cable 9 with a logic unit 9 that is construed as personal computer. Image data is transferred over the data cable 9 from the camera 8 to the logic unit 10. Instead of a data cable 9 a radio connection can also be provided.

The logic unit 10 can alternatively also be integrated in the camera or in the robotic vehicle 2.

The logic unit 10 comprises a visualizing unit 11 (screen) for visualizing the image data, thus the robotic vehicle 2 as well as the work area 3, in particular the external border 4, the internal border 5 and the static obstacle 6.

The logic unit 10 is furthermore connected to an input unit 12, with which it can be selected from default driving strategies and driving strategies can be created or adjusted for the robotic vehicle 2. Furthermore omitted areas within the work area 3 can be determined over the input unit 12 and external and internal borders 4, 5 can be defined or changed.

The logic unit 10 calculates driving instructions for the robotic vehicle 2 based on the image data and any further data or parameter, which are for example entered over the input unit 11 or fed in over a data carrier or the internet. The driving instructions are thereby preferably calculated in such a way that the robotic vehicle 2 drives along the work area 3 in a certain driving strategy—in the present case a meander-shaped driving strategy with tracks 13 that are parallel to each other and overlap each other in certain areas. The driving instructions are calculated in such a way that the external border 4 as well as the internal border 5 are not driven over, thus the robotic vehicle 2 remains within the work area 3. Besides the static obstacle 6 also temporarily occurring obstacles are detected and driven around with the aid of corresponding driving instructions. One driving instructions can also be to stop the robotic vehicle 2 (temporarily).

The logic unit 10 or a computer program that is installed on it is furthermore construed in such a way that differently conditioned sections (mowed/not mowed) 3a, 3b are detected and the driving instructions are calculated in such a way that preferably the not mowed section 3b is driven along.

In order for the robotic vehicle 2 to able to react to the driving instructions that have been calculated by the logic unit 10, the logic unit 10 is connected in this embodiment with a transmitting unit 15 over a further data cable 14, with which the driving instructions are transmitted to a receiving unit 16 at the robotic vehicle 2. The receiving unit 16 is connected to a control unit 18 over a further data cable 17, whereby the control unit 18 controls the not further shown drive means of the robotic vehicle 2 based on the driving instructions that have been received by the receiving unit 16 in such a way, that the robotic vehicle 2 follows the calculated tracks 13 and when detecting a certain obstacle 6 it avoids it or reacts by other means.

For an improved position detection of the robotic vehicle 2 it is helpful to apply marks 19 (in this embodiment LEDs), which make it more simple for the logic unit 10 to detect the position and/or orientation of the robotic vehicle 2 as well as to track its movement.

The robotic vehicle 2 comprises in the shown embodiment a transmitting unit 20 besides the receiving unit 16, whereby the receiving unit 16 and the transmitting unit 20 can also be construed as combined receiving- and transmitting unit. With the aid of the transmitting unit 20 the robotic vehicle 2 transmits status information of the robotic vehicle 2 to an external receiving unit 21, which is connected to the logic unit 10 over a data cable 22. The external receiving unit 21 as well as the external transmitting unit 15 can also be construed as combined transmitting- and receiving unit. The status information that is transferred over the data cable 22 from to the logic unit 10 is considered by the logic unit 10 when calculating the driving instructions for the robotic vehicle 2, for example in such a way that the robotic vehicle 2 drives directly to the charging station 7 and docks into it when detecting a low accumulator load status.

Besides the driving instructions the logic unit can create a start instruction and/or a stop instruction for the not further shown mower of the robotic vehicle 2, whereby these instructions are transmitted to a receiving unit 16 over the external transmitting unit 15 and correspondingly converted by the control unit 18. Thus a stop instruction is for example send out to the mower when detecting a temporary obstacle, also when the robotic vehicle 2 drives over the not mowed section 3a of the work area 3.

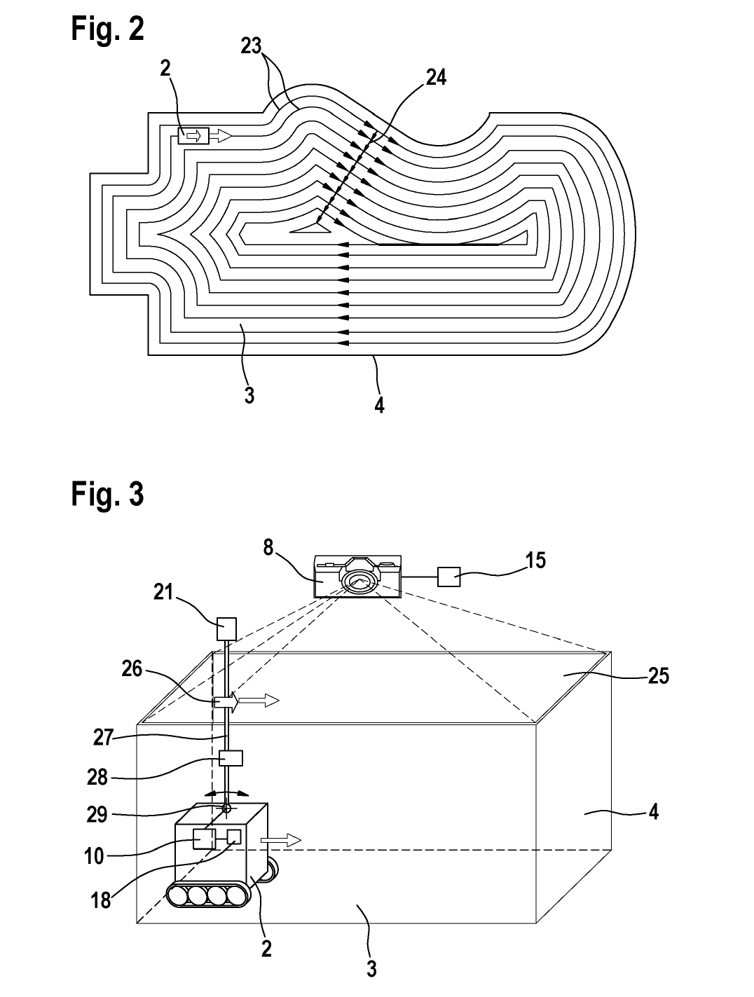

FIG. 2 shows a possible trajectory for the robotic vehicle 2, which is automatically calculated by the logic unit 10 based on the distance information to the external border 4 of the work area 3 that is determined by the image data of the camera 8. The control unit 18 controls the drive means of the robotic vehicle 2 depending on these driving instructions, which means depending on the constantly determined distance information to the external border. The shown trajectory has been determined by the logic unit 10 with the aid of the image processing operation erosion with a gradually increased erosion filter mask (for example circular mask for round and rectangular for rectangular contours). As it can be seen in FIG. 2 almost the entire work area 3, except the innermost area, can be driven along in such a way that the same surface area is not driven along several times. A connecting line 24 (radial line) is shown besides the at least approximately parallel rounds 23 or ring tracks, whose diameter becomes smaller externally, and whose contours are adjusted to the contours of the external border 4. After driving each round 23 the robotic vehicle 2 arrives at the (virtual) connecting line 24. The arriving at this connecting line 24 can be determined with the aid of the above arranged camera 8, which continuously detects the position of the swimmer. When arriving at the connecting line 24 the robotic vehicle 2 shifts to an adjoining approximately parallel round 23 or ring track that lies radially further inside.

FIG. 3 shows an automatic activation system 1 for a robotic vehicle 2 that is construed as a pool-robot. The robotic vehicle 2 comprises not shown drive means, in particular a drive motor and a steering device for steering the robotic vehicle 2, or like in the previous embodiment, two drive units, which both together create a differential drive. The drive motor is construed in the embodiment as electric motor, which is operated with the aid of an also not shown accumulator.

The robotic vehicle 2 is located on a work area 3, which is created by a pool bottom. The external border 4 of the work area 3 is created by the surrounding pool walls.

For an optical detection of the robotic vehicle 2 or a swimmer 26 that is swimming on the water surface 25, which is carried along with the robotic vehicle 2 when driving along the work area 3 over a guiding rod 27 that is flexibly connected with the robotic vehicle 2, a camera 8 is provided, which is construed as a color digital camera and which is arranged above the water surface 25. Since the camera can be pivoted by a link 29 relative to the robotic vehicle, a further swimmer 28 is provided below the swimmer 26 that is adjustable relatively to the guiding rod 27, which is firmly connected to the guiding rod 22 and adjusts it vertically.

The camera 8 is connected with the transmitting unit 15 in a signal-conducting manner, over which image data is transmitted to a receiving unit 21, which is attached at the guiding rod 27, and which is connected with a logic unit 10 within the robotic vehicle 2 in a signal-conducting manner. The logic unit 10 is connected in a signal-conducting way with a control unit 18, which controls the not shown drive means. Additionally further transmitting- and receiving units can be provided for the communication, analogous to the embodiment according to FIG. 1. It is furthermore possible to construe the logic unit 10 not as internal logic unit 10 that is directly assigned to the robotic vehicle 2 like in the embodiment according to FIG. 1, but as an external logic unit 10, which is connected in a signal-conducting way with the digital camera 8, whereby the data transferring mechanism functions preferably as in the embodiment according to FIG. 1.

The swimmer 26 that is only indicated by an arrow has preferably a width (expansion transversely to the driving direction of the robotic vehicle 2), which corresponds with the width of the robotic vehicle 2. Thereby no camera calibration is required and the robotic vehicle can even be correctly positioned in the external areas further away from the CAM despite perspective deformation/illustration. If the mark width on the swimmer or the width of the swimmer itself corresponds with the track width the perspective of the camera (deformation, perspective illustration) does not matter, because the camera can always compare the external borders of the marker or the swimmer with adjoining tracks and keep the robotic vehicle distanced.

The logic unit 10 preferably calculates a trajectory that is construed analogously to FIG. 2, whereby the individual rounds or ring tracks then provide a mainly rectangular contour in the shown embodiment according to FIG. 3, thus a contour, which is adjusted to the rectangular contour of the external border 4.

1. Activation system for a robotic vehicle,
with at least one external camera, which is configured for generating image data of a work area as well as at least one robotic vehicle, and
with at least one, preferable external, logic unit, which is configured for determining the position of the at least one robotic vehicle and for calculating driving instructions for the at least one robotic vehicle based on the image data that has been generated by the camera,
with an external transmitting unit, which is configured for transmitting the driving instructions and/or for transmitting the image data, and
with a control unit that is configured for activating drive means of at least one robotic vehicle based on the driving data.

2. The activation system according to claim 1, wherein the external logic unit is configured in such a way that it detects the borders of the work area and calculates the driving instructions in such a way that a robotic vehicle does not leave the work area.

3. The activation system according to claim 1 the external logic unit is configured in such a way that it detects static and/or moved obstacles in a work area and calculates the driving instructions in such a way that a robotic vehicle does not collide with the obstacles.

4. The activation system according to claim 1, wherein, in that the external logic unit is configured in such a way that it detects the orientation of a robotic vehicle and considers it when calculating the driving instructions.

5. The activation system according to claim 1, wherein, in that the external logic unit considers weather data and/or time data when calculating the driving instructions.

6. The activation system according to claim 1, wherein the external logic unit is configured in such a way that it detects differently conditioned sections of the work area and considers them when calculating the driving instructions.

7. The activation system according to claim 1, wherein the external unit is assigned to an input unit for a manual determining and/or changing of borders of the work area and/or obstacles and/or driving patterns and/or a visualizing unit for visualizing the image data and/or the obstacles and/or the driving patterns.

8. The activation system according to claim 1, wherein the logic unit is configured in such a way, that it calculates the driving instructions in such a way that the work area is driven along by the robotic vehicle according to a certain, in particular selectable and/or readable driving pattern, especially on parallel tracks and/or on overlapping tracks.

9. The activation system according to claim 1, wherein a transmitting unit, arranged at a robotic vehicle, for transmitting status data, in particular odometry data/or accumulator load status data, and an external receiving unit, connected with the external logic unit, for receiving the status data, are provided.

10. The activation system according to claim 9 wherein the logic unit considers the status data when calculating the driving instructions.

11. The activation system according to claim 1, wherein the system comprises at least one robotic vehicle, in particular a robotic vehicle with drive means.

12. The activation system according to claim 11, wherein the at least one receiving unit is arranged at the robotic vehicle.

13. The activation system according to claim 11, wherein the at least one control unit is arranged at the robotic vehicle.

14. The activation system according to claim 11, wherein at least one mark, in particular a LED, is provided at the robotic vehicle for a simplified determination of the position and/or orientation of the robotic vehicle.

15. The activation system according to claim 11, wherein the robotic vehicle is a gardening tool, in particular for a surface treatment near the ground, preferably a lawnmower with a mower, or a leaf collecting vehicle, or a grass collecting vehicle, or a mobile watering facility, or a thatching vehicle, or a weeding vehicle, or a snow cleaning vehicle, or a seed distributing vehicle, or a fertilizing vehicle, or a harvesting vehicle, or in that the robotic vehicle is a cleaning or supervising robot, in particular for supermarkets, airports or train stations or such alike.

16. The activation system according to claim 1, wherein the logic unit creates a starting instruction and a stopping instruction for a tool, in particular a mower, of a robotic vehicle based on the image stat.

17. The activation system according claim 1, wherein the logic unit calculates a trajectory of a robotic vehicle depending on the image data that is provided by the camera, preferably in such a way that the entire work area or a pre-determined or pre-determinable section of the work area, is driven along at least almost completely, in particular in such a way, that no surface section is driven along several times.

18. The activation system according to claim 1, wherein, in that the logic unit calculates a trajectory that runs clockwise or contra-clockwise by the image procession operation erosion.

19. The activation system according to claim 11, wherein the logic unit is controls drive means in such a way that a robotic vehicle drives along the work area in several, in particular oriented at the internal or external border of the work area, rounds, whereby the robotic vehicle maintains a round-specific distance to the external or internal border during each round, whereby the distance that is determined by erosion is increased or reduced with every round by a measure of length that is determined by an erosion filter mask.

20. The activation system according to claim 19 wherein the defined measure of length corresponds at least approximately with the width of the robotic vehicle or at least approximately with the width of a working element of the robotic vehicle.

21. The activation system according to claim 11, wherein the robotic vehicle is a pool robotic vehicle, and in that the robotic vehicle is connected to a swimmer that is detected by the camera and swims above the robotic vehicle.

22. The activation system according to claim 21 wherein the width of the swimmer corresponds with the width of the robotic vehicle and/or the width of a working element of the robotic vehicle, in particular the width of a filter unit and/or a suction unit and/or a cleaning unit.
